(19) United States
(12) Patent Application Publication
(10) Pub. No.: US 2009/0282155 A1
(43) Pub. Date: Nov. 12, 2009

(54) PROVIDING PEER-TO-PEER MEDIA

(75) Inventor: Rashad Mohammad Ali, Plano, TX (US)

Correspondence Address: FISH & RICHARDSON P.C., P.O. BOX 1022, MINNEAPOLIS, MN, 55440-1022, US

(73) Assignee: Mavenir Systems, Inc., Richardson, TX (US)

(21) Appl. No.: 12/118,181

(22) Filed: May 9, 2008

(51) Int. Cl. G06F 15/16

(52) U.S. Cl. 709/228; 709/227

(57) ABSTRACT

This disclosure provides a system and method for providing peer-to-peer multimedia. In some embodiments, a method includes identifying media devices based, at least in part, on a call session between communication devices. Peer-to-peer multimedia is provided between the identified media devices.

### TECHNICAL FIELD

This invention relates to network communications and, more particularly, to providing peer-to-peer media.

### BACKGROUND

Communication networks include wired and wireless networks. Example wired networks include the Public Switched Telephone Network (PSTN) and the Internet. Example wireless networks include cellular networks as well as unlicensed wireless networks that connect to wire networks. Calls and other communications may be connected across wired and wireless networks.

Cellular networks are radio networks made up of a number of radio cells, or cells, that are each served by a base station or other fixed transceiver. The cells are used to cover different areas in order to provide radio coverage over a wide area. Example cellular networks include Global System for Mobile Communication (GSM), Universal Mobile Telecommunications System (UMTS), Wide-band Code Division Multiple Access (WCDMA), and CDMA2000. Cellular networks communicate in a radio frequency band licensed and controlled by the government. Unlicensed wireless networks are typically used to wirelessly connect portable computers, PDAs and other computing devices to the internet or other wired network. These wireless networks include one or more access points that may communicate with computing devices using an 802.11 and other similar technologies.

In regards to Internet protocol (IP) call sessions, Session Initiation Protocol (SIP) enables end user applications the ability to create and manage sessions between IP end points, where a session is considered a exchange of data between an association of participants. SIP provides methods to enable IP end points to discover one another and exchange parameters related to the set up of sessions between the IP end points. In order to accomplish this processes, SIP defines network hosts to which SIP clients or user agents at IP end points can send registrations and session invitation and other requests. These SIP Proxy Servers perform registration, discovery, session management and redirection functions for IP end point for establishing and terminating call sessions.

### SUMMARY

This disclosure provides a system and method for providing peer-to-peer multimedia. In some embodiments, a method includes identifying media devices based, at least in part, on a call session between communication devices. Peer-to-peer multimedia is provided between the identified media devices.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustrating a communication system in accordance with some embodiments of the present disclosure;

FIGS. 2A and 2B illustrate communication sessions in communication system of FIG. 1 in accordance with some embodiments of the present disclosure; and

FIG. 3 illustrates a flow diagram illustrating an example method for providing peer-to-peer multimedia in communication system of FIG. 1 in accordance with some embodiments of the present disclosure.

### DETAILED DESCRIPTION

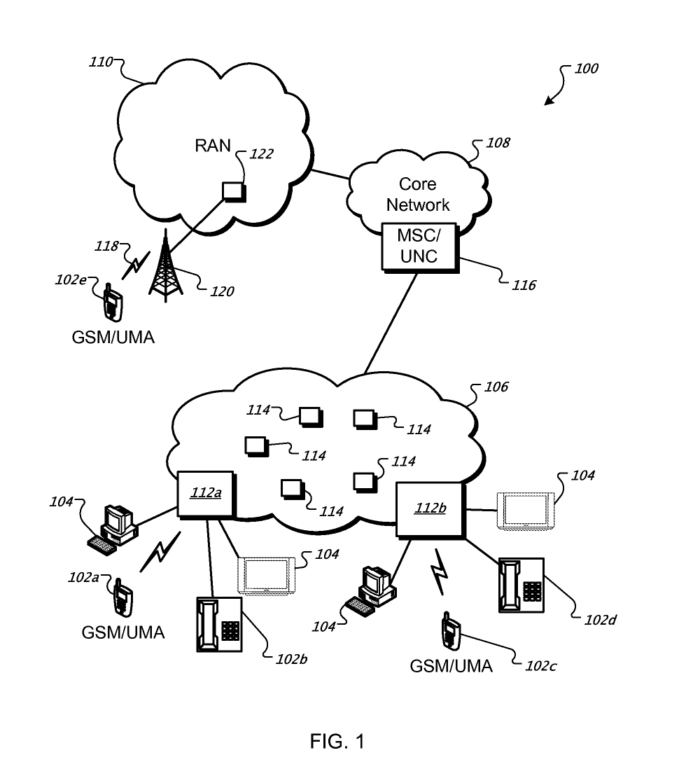

FIG. 1 illustrates a communication system 100 for using communication session technology to provide peer-to-peer media. For example, system 100 may identify location information of media devices 104 using communication session technologies and provide peer-to-peer media using the location information. In some embodiments, system 100 directly routes media between two media devices 102 through an Internet Protocol (IP) network using location information determined from a communication session, such as a call session between communication devices 102. Media may be data, video, audio, multimedia or other sessions in which information and requests are exchanged. Communication session technology may include cellular radio technologies, broadband technologies, or any other suitable communication session technology that may identify a location of a device 102. Cellular radio technologies include Global System for Mobile Communication (GSM) protocols, Code Division Multiple Access (CDMA) protocols, Universal Mobile Telecommunications System (UMTS), or any other suitable communication technology for transmitting wireless call signals. Broadband technologies include Session Initiation Protocol (SIP), Unlicensed Mobile Access (UMA), proprietary protocols, and any other suitable protocols for formatting data for broadband communication. In addition to exchanging location information, system 100 may exchange IP end point capabilities and/or connectivity information to enable a secure connectivity between IP end points such as secure IP tunnels. For example, system 100 may identify information regarding supported sessions at media devices 104 (e.g., Codec, data rates, services) and/or information regarding media devices 104 themselves (e.g., device type, display information, operating system, storage space, routable address, radio interface, Ethernet interface, uplink/downlink bandwidth, SIM, public keys). In doing so, system 100 may enable IP end point connectivity without the need for additional network elements to be deployed in wireless and/or fixed line networks.

At a high level, system 100 includes communication devices 102 and media devices 104 coupled via IP network 106, a core network 108, a Radio Access Network (RAN) 110, and network nodes 112. Each communication devices 102 comprises electronic devices operable to receive and transmit calls within system 100. As used in this disclosure, communication devices 102 may include cellular phones, data phones, smart phones, soft phones, personal data assistants (PDAs), one or more processors within these or other devices, or any other suitable processing devices capable of receiving and transmitting calls in system 100. In some embodiments, communication devices 102 may use cellular radio technology (e.g., GSM) and/or unlicensed radio technology (e.g., UMA) to transmit and/or receive calls. In some embodiments, communication devices 102 may use SIP to transmit and/or receive calls. In short, devices 102 generates requests, responses or otherwise communicates with other devices 102 via network 106. Each media devices 104 comprises electronic devices operable to receive and/or transmit media within system 100. As used in this disclosure, media devices 102 may include communication devices 102, computers, displays, media storage devices, audio systems, personal data assistants (PDAs), one or more processors within these or other devices, or any other suitable processing devices capable of receiving and/or transmitting media in system 100. In some embodiments, media devices 102 may use broadband technologies (e.g., SIP) to transmit and/or receive media.

IP network 106 facilitates wireline communication between devices 102 and 104 in system 100. As described, network 106 communicates Internet Protocol (IP) packets to transfer voice, video, data, and other suitable information between network addresses. In the case of multimedia sessions, network 106 may use Voice over IP (VoIP) protocols to set up, route, and tear down calls. In some embodiments, network 106 uses SIP to establish media sessions. Network 106 may include one or more local area networks (LANs), metropolitan area networks (MANs), wide area networks (WANs), all or a portion of the global computer network known as the Internet, and/or any other communication system or systems at one or more locations. In the illustrated embodiment, IP network 106 includes SIP proxy servers 112 for routing SIP messages. Each SIP proxy server 112 can be any software, hardware, and/or firmware operable to route SIP messages to other SIP proxies 112, gateways, devices 102, devices 104, and others. In routing SIP messages, the included media is often transparent to standard SIP proxy servers 112. The standard SIP proxy servers 112 typically acts on the standard SIP headers of the SIP message for routing/forwarding decisions of the SIP message and ignores the media in the message body.

Cellular core network 108 typically includes various switching elements and gateways for providing cellular services. Cellular core network 108 often provides these services via a number of RANs, such as RAN 110, and also interfaces the cellular system with other communication systems such as IP network 106 via mobile switching center (MSC) 116. In accordance with the GSM standard, cellular core network 108 includes a circuit switched (or voice switching) portion for processing voice calls and a packet switched (or data switching) portion for supporting data transfers such as, for example, e-mail messages and web browsing. The circuit switched portion includes MSC 116 that switches or connects telephone calls between RAN 110 and IP network 106 or other network. The packet-switched portion, also known as General Packet Radio Service (GPRS), includes a Serving GPRS Support Node (SGSN) (not illustrated), similar to MSC 116, for serving and tracking mobile devices 102 using cellular communication technology, and a Gateway GPRS Support Node (GGSN) (not illustrated) for establishing connections between packet-switched networks and mobile devices 102. The SGSN may also contain subscriber data useful for establishing and handing over call connections. Cellular core network 108 may also include a home location register (HLR) for maintaining “permanent” subscriber data and a visitor location register (VLR) (and/or a SGSN) for “temporarily” maintaining subscriber data retrieved from the HLR and up-to-date information on the location of mobile devices 102. In addition, cellular core network 108 may include Authentication, Authorization, and Accounting (AAA) that performs the role of authenticating, authorizing, and accounting for devices 102 operable to access cellular core network 108.

In some embodiments, MSC 116 includes a UMA Network Controller (UNC) to manages devices 102 that wirelessly accessing IP network 106. MSC/UNC 116 can include any software, hardware, and/or firmware operable to manage UMA devices 102. For example, MSC/UNC 116 may perform registration for UMA control services, set up or tear down bearer paths, terminate secure remote access tunnels from enterprise devices, and other suitable services. In addition, MSC/UNC 116 may provide location information for devices 102. In general, MSC/UNC 116 monitors devices 102 via network 106. For example, MSC/UNC 116 may store the identity, location, and/or capabilities of devices 102 during registration. MSC/UNC 116 may require such information to provide support services and/or potentially handover functionality for devices 102. After registration is approved by MSC/UNC 116, the current location information is updated in core network 108.

RAN 110 provides a radio interface between mobile devices 102 and cellular core network 108 that may provide real-time voice, data, and multimedia services (e.g., a call) to mobile devices 102. In general, RAN 110 communicates air frames 118 via radio frequency (RF) links. In particular, RAN 110 converts between air frames 118 to physical link based messages for transmission through cellular core network 108. RAN 110 may implement, for example, one of the following wireless interface standards during transmission: IS-54 (TDMA), Advanced Mobile Phone Service (AMPS), GSM standards, CDMA, Time Division Multiple Access (TDMA), General Packet Radio Service (GPRS), ENHANCED DATA rates for Global EVOLUTION (EDGE), or proprietary radio interfaces.

RAN 110 may include Base Stations (BS) 120 connected to Base Station Controllers (BSC) 122. BS 120 receives and transmits air frames 118 within a geographic region of RAN 110 called a cell and communicates with mobile devices 102 in the cell. Each BSC 122 is associated with one or more BS 120 and controls the associated BS 120. For example, BSC 122 may provide functions such as handover, cell configuration data, control of RF power levels or any other suitable functions for managing radio resource and routing signals to and from BS 120. MSC 116 handles access to BSC 122. MSC 116 may be connected to BSC 122 through a standard interface such as the A-interface.

Network nodes 112 may perform the following two functions: providing an access point for devices 102 and 104 and providing peer-to-peer media. As for access point operations, nodes 112 can include any software, hardware, and/or firmware operable to receive messages transmitted using cellular radio technologies and/or broadband technologies. In addition, nodes 112 may generate IP packets (e.g., UMA packets) based, at least in part, on received cellular radio technology and/or unlicensed radio technology messages. In some embodiments, nodes 112 may convert between different communication technologies. For example, node 112 may receive a message including media from IP network 106 and convert the IP message to a communication technology compatible with the destination device 102 or 104. For example, such communication technology may include digital television service (IPTV), Public Switch Telephone Network (PSTN), High Speed Downlink Packet Access (HSDPA), Peer-to-Peer (P2P) technologies (e.g., Googletalk, Skype, XMPP, Jabber), Unlicensed Mobile Access (UMA) technology, Real Time Streaming Protocol (RTSP) technologies (e.g., RealPlayer, Quicktime, Media Player), and others. In some embodiments, nodes 112 may convert parameters from a first cellular radio technology, such as UMTS, to a second cellular radio technology, such as GSM. After converting to a suitable communication technology, nodes 112 may transmit the converted message to the destination device 102 or 104. In addition to converting between different communication technologies, node 112 may receive, identify, or otherwise include information associated with devices 102 and 104 that are directly coupled to node 112. For example, node 112 may include information regarding sessions supported by a device 102 or 104 and/or information regarding the device 102 or 104. In the case of sessions supported, node 112 may include information such as Codec, data rates, services, and/or others. As for information regarding the device 102 or 104, node 112 may include a device profile (e.g., device type, display information, operating system, storage space), connectivity and bandwidth information (e.g., routable address, radio interface, Ethernet interface, uplink/downlink bandwidth), and/or security parameters/profile (e.g., SIM, public keys).

Now turning to the intra-network switching, node 112 may provide peer-to-peer media between devices 102 and/or 104. Node 112 can include any software, hardware, and/or firmware operable to switch, route, or otherwise direct ingress and egress messages. To facilitate switching of traffic, node 112 may determine a location of communication devices 102 using the associate communication technology. In the case of GSM/UMA devices 102, core network 118 may maintain location information associated with such devices 102. In the case of SIP devices 102, associated SIP proxy servers 114 may maintain location information associated with such devices 102. Node 112 may identify this location information in ingress messages and use the identified location information to switch IP messages between media devices 104. For example, node 112 may identify the location of a mobile device 102 based, at least in part, on a message including cellular radio technology. Once node 112 determines the location of device 102, node 112 may update its routing tables to enable intra-network switching. For example, node 112a may receive a message that includes information identifying node 112b that the message was previously routed through. Using this path information, node 112a may update an associated routing table. As a result, node 112a may transmit media sessions directly to node 112b and, thus, provide intra-network switching within network 106. Prior to transmitting media between nodes 112a and 112b, nodes 112a and node 112b may exchange information (e.g., security parameters) for establishing a connection between media devices. For example, the exchanged information may related to establishing secure IP tunnels, devices 102 and/or 104 capabilities, services supported by each device 102 and/or 104, and/or other information. Nodes 112a and 112b may exchange information using out of band signaling such as one or more of the following: User-to-User Signaling methods (USSD), Extensions in Call Setup Messages, Short Message Service (SMS), Packet Data Service in a wireless or wireline network, or others. In some embodiments, nodes 112a and 112b exchange information establish a secure IP tunnel between media devices 104. In this case, nodes 112 may include secure media gateways for establishing the secure IP tunnel. After or in connection with establishing an IP tunnel between devices 104, nodes 112a and 112b may further exchange, over the established IP tunnel, additional security parameters related to accessing various individual services available at media devices 104. While the method of exchanging information has been described as between nodes 112a and 112b, the information may be directly exchanged between peers such as media devices 104.

In one aspect of operation, communication device 102a transmits a call request to MSC/UNC 116 for establishing a call with communication device 102c. In response to at least receiving the call request, MSC/UNC 116 identifies the location of communication device 102c and transmits the message to node 112b. Node 112b receives the call request and identifies the location of node 112a based, at least in part, on the message. Node 112b may update an associated routing table. Node 112b forwards the call request to communication device 102c. In response to at least the request, communication device 102c establishes a call session with communication device 102b. In some embodiments, the call session may be established independent of MSC/UNC 116 using the identified location information. In connection with the established call session, node 112a may receive a request to transmit media to a media device 104 associated with node 112b. To provide peer-to-peer media, node 112a and 112b may exchange information prior to transmitting the media between media devices 104. For example, node 112b may transmit information indicating capabilities of media devices 104 associated with node 112b and/or as well as information identifying aspects of the destination media device 104. In doing so, node 112a and 112b may establish a secure IP tunnel between media devices 104 and/or transmit the media in accordance with session information as well as device information.

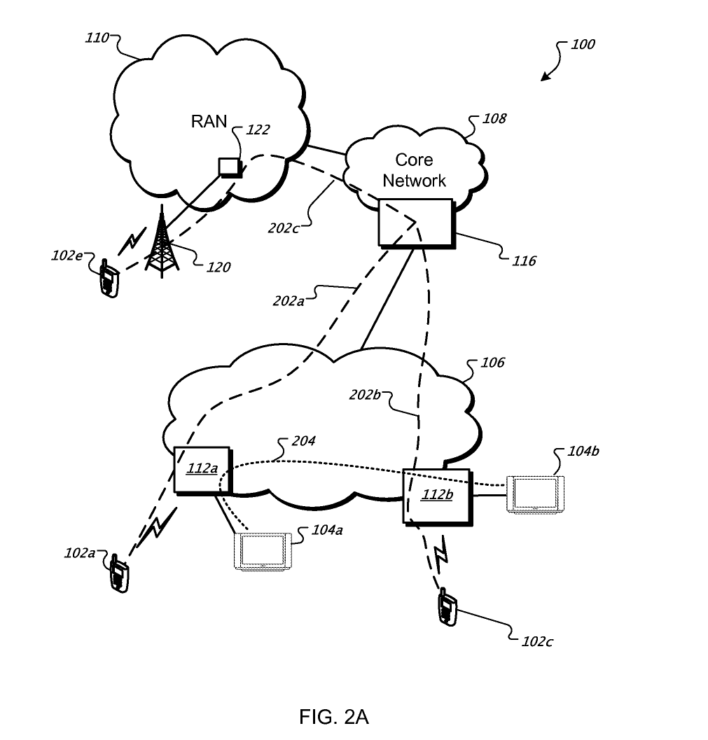

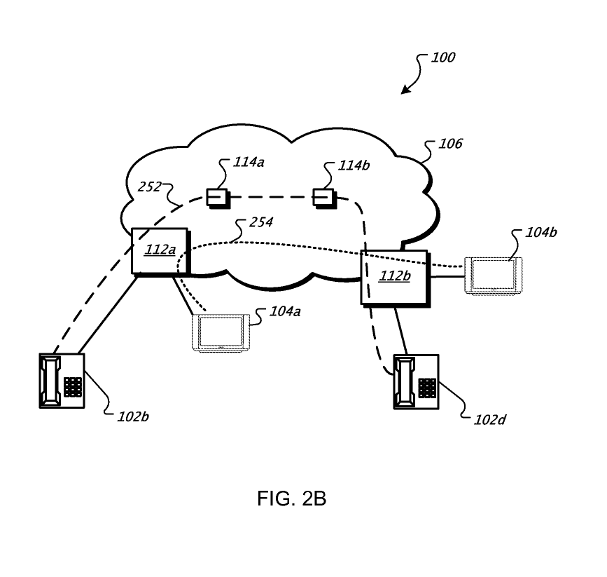

FIGS. 2A and 2B are block diagrams that illustrate providing peer-to-peer media using location services of different communication technologies (e.g., GSM, SIP). For ease of reference, only some of the elements of communication system 100 of FIG. 1 are shown. In the illustrated embodiment, devices 102 and 104 communicate via nodes 112a and 112b. Initially, both devices 102 and 104 establish call sessions using associated location aware network elements such as MSC/UNC 116 or SIP proxy servers 114. Devices 102 may establish a call session using such network elements and then request media be exchange between devices 104. In general, nodes 112a and 112b may include routing tables that include location data for devices 102 and 104 in system 100. These routing tables may be dynamic such that nodes 112a and/or node 112b updated them in response to at least receiving location information. As a result, system 100 may be able to provide intra-network switching of communication sessions include media sessions between devices 104 independent of MSC/UNC 116 or managing SIP proxy server 114.

Referring to FIG. 2A, mobile device 102a, in one aspect of operation, wirelessly transmits to node 112a a request to initiate a call with mobile device 102c. In some embodiments, node 112a receives a UMTS message and generates a UMA message based, at least in part, on the UMTS message. In the event that node 112a does not contain information identifying the location of mobile device 102c, node 112a forwards the request to MSC/UNC 116 through IP network 106 as illustrated by call leg 202a. In some embodiments, node 102a modifies the request to include information identifying that the signal was routed through node 112a. MSC/UNC 116 identifies the location of mobile device 102c and directs the signal to node 112b, illustrated as call leg 202b. Similarly, mobile device 102e may transmit a call request to mobile device 102c via RAN 110 and core network 108. As with the initial signal, the response from mobile device 102c may include location information of mobile device 102c and/or node 112b, and thus, node 112a may update routing tables indicating that messages destined for mobile device 102c be directly routed to node 112b, not default MSC/UNC 116. In the event that mobile device 102a transmits to node 112a a request to forward media to mobile device 102c, node 112a may directly provide the identified media to node 112b. In some embodiments, node 112a transmits a request to and/or retrieves the data from media device 104a. After identifying the source of the media, node 112a may identify the destination media device 104b for receiving the request media. In this case, node 112a may provide media to media device 104b independent of MSC/UNC 116, illustrated as media session 204. In other words, node 112a may provide the request media directly to media device 104b using location information identified from the call session between communication devices 102. In some embodiments, nodes 112a and nodes 112b, prior to transmitting media, exchange information to establish media session 204. In this case, nodes 112a and nodes 112b may exchange information indicating media sessions that media devices 104a and 104b support. For example, the exchanged information may include Codec, data rates, services, and/or other information. In addition or alternatively, nodes 112a and nodes 112b may exchange information regarding media devices 104a and 104b. For example, the exchanged information may include device type, display information, operating system, connectivity (e.g., routable address, radio interface, Ethernet interface), security parameters (e.g., SIM, public keys), and/or other information. After exchanging information, nodes 112a and 112b may establish call leg 204 for transmitting the media from media device 104a to media device 104b. In some embodiments, nodes 112a and 112b establish a secured tunnel between media device 104a and media device 104b.

In another aspect of operation, mobile device 102e may transmit a request to initiate a call session with mobile device 102c via RAN 110 and core network 108. MSC/UNC 116 identifies the location of mobile device 102c and directs the signal to node 112b. After a call session is established between mobile devices 102c and 102e, device 102e may transmits a request to node 112a to forward media to media device 102b associated with mobile device 102c. In response to at least the request, node 112a provides the identified media to node 112b. In some embodiments, the request identifies the location of node 112b and, in this case, the media may be routed directly to node 112b independent of MSC/UNC 116. In some embodiments, node 112a transmits a request to and/or retrieves the data from media device 104a. In other words, node 112a may provide the requested media directly to media device 104b using location information identified from the call session between communication devices 102. As discussed above, nodes 112a and nodes 112b, prior to transmitting media, may exchange information to establish call leg 204. After exchanging information, nodes 112a and 112b may establish media session 204 for transmitting the media from media device 104a to media device 104b. In some embodiments, nodes 112a and 112b establish a secured IP tunnel between media device 104a and media device 104b.

Referring to FIG. 2B, SIP device 102b, in one aspect of operation, transmits a request to initiate a call with SIP device 102d to node 112a. In the event that node 112a does not contain information identifying the location of SIP device 102d, node 112a forwards the request to a SIP proxy server 114a associated with SIP device 102b. In some embodiments, node 112a modifies the request to include information identifying that the signal was routed through node 112a. SIP proxy server 114a identifies a SIP proxy server 114b associated with SIP device 102d and routes the request to the associated SIP proxy server 114b. After receiving the request to initiate a call session, SIP proxy server 114b identifies location information associated with SIP device 102d and routes the request through IP network 106 to node 112b, illustrated as call session 252. In response to at least receiving the request, node 112b may identify the location of node 112a based, at least in part, on the request and may store the location information. For example, node 112b may update an associated routing table with the location information of node 112a, device 102b, and/or device 104a.

As with the initial signal, the response from SIP device 102d may include location information of SIP device 102d and/or node 112b, and thus, node 112a may update routing tables indicating that messages destined for SIP device 102d be directly routed to mobile device 102c, not default SIP proxy server 114a. In the event that mobile device 102a transmits to node 112a a request to forward media to mobile device 102c, node 112a provides the identified media to node 112b, illustrated as media session 254. In some embodiments, node 112a transmits a request to and/or retrieves the data from media device 104a. After identifying the source of the media, node 112a may identify the destination media device 104b for receiving the request media. In this case, node 112a may provide media to media device 104b independent of call managing SIP proxy servers 114. In other words, node 112a may provide the request media directly to media device 104b using location information identified from call session 252. In some embodiments, nodes 112a and nodes 112b, prior to transmitting media, exchange information to establish media session 254. In this case, nodes 112a and nodes 112b may exchange information indicating media sessions that media devices 104a and 104b support. For example, the exchanged information may include Codec, data rates, services, and/or other information. In addition or alternatively, nodes 112a and nodes 112b may exchange information regarding media devices 104a and 104b themselves. For example, the exchanged information may include device type, display information, operating system, connectivity (e.g., routable address, radio interface, Ethernet interface), security parameters (e.g., SIM, public keys), and/or other information. After exchanging information, nodes 112a and 112b may establish media session 254 for transmitting the media from media device 104a to media device 104b. In some embodiments, nodes 112a and 112b establish a secured IP tunnel between media device 104a and media device 104b.

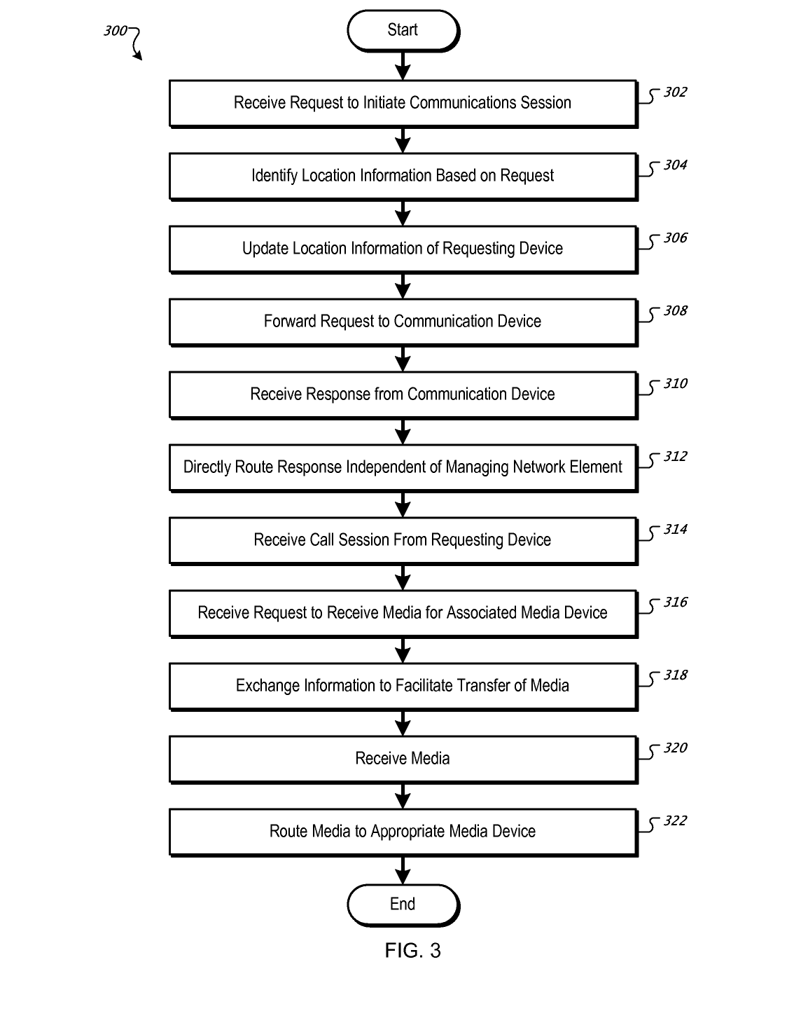

FIG. 3 illustrates an example method 300 for providing peer-to-peer multimedia in communication system 100. Method 300 is described with respect to node 112 of FIG. 1, but method 300 could be used by any other application or applications. Moreover, node 112 may use any other suitable techniques for performing these tasks. Thus, many of the steps in this flowchart may take place simultaneously and/or in different orders as shown. Further, node 112 may execute logic implementing techniques similar to method 300 in parallel or in sequence. Node 112 may also use methods with additional steps, fewer steps, and/or different steps, so long as the methods remain appropriate.

At a high level, method 300 includes the following two process: determining location information of media devices 104 based, at least in part, on a call session and transferring media directly between media devices 104 in accordance with the location information. Method 300 begins at step 302 where node 112b receives a request to initiate a call session with a communication device 102. In response to at least receiving the request, node 112b, at step 304, identifies location information associated with the requesting communication device 102 and updates the location information of the requesting communication device 102 at step 306. For example, node 112b may update a routing table with the location information of communication device 102. At step 308, node 112b forwards the request to the appropriate communication device 102. Next, node 112b receives a response to the request. Node 112b directly routes the response to the requesting communication device 102 independent of a managing network element (e.g., MSC/UNC 116, SIP proxy server 114) using the updated location information at step 312. For example, node 112b may directly route the response to node 112a independent of the managing SIP proxy server 114 or MSC/UNC 116. At step 314, nodes 112a and 112b establish the call session between communication devices 102.

In connection with identifying location information of communication devices 102 participating in the call session, node 112b, at step 316, receives a request to receive media for an associated media device 104. For example, node 112b may receive a request to receive audiovisual media for display 104. In response to at least this request, node 112b exchanges information with node 112a for establishing a media session between media devices 104 at step 318. In connection with the exchanged information, node 112b, at step 320, receives the media and, in turn, routes the received media to the appropriate media device 104.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method, comprising:
identifying media devices based, at least in part, on a call session between communication devices; and
providing peer-to-peer multimedia between the identified media devices.

2. The method of claim 1, wherein identifying media devices comprising identifying location information associated with the media devices based, at least in part, on the call session between the communication devices.

3. A method, comprising:
identifying a first location of a first communication device and a second location of a second communication devices based, at least in part, on a call session between the first and second communication device; and
providing peer-to-peer multimedia between media devices using the first location and the second location.

4. The method of claim 1, further comprising receiving information identifying capabilities of the media devices.

5. A method, comprising:
identifying location information associated with a first and second mobile device based, at least in part, on a radio cellular technology; and
directly routing media between a first and second media device using the location information and independent of the radio cellular technology.

6. The method of claim 1, the radio cellular technology comprising Global System for Mobile Communication (GSM), the media routed independent of the UMA Network Controller (UNC).

7. A method, comprising:
receiving a call initiation request for a first communication device from a second communication device;
identifying location information associated with the second communication device based, at least in part, on the call initiation request;
directly routing media to a media device associated with the second communication device based, at least in part, on the location information.

8. The method of claim 7, the call initiation request comprising a Session Initiation Protocol (SIP) request or a GSM request.

9. The method of claim 7, the media device comprising a first media device, the method further comprising:
receiving a request from the second communication device to transmit media to the first media device media device;
identifying a second media device storing the requested media and associated with the first communication device; and
transmitting information identifying capabilities of the second media device.

10. The method of claim 7, further comprising receiving information identifying capabilities of the first communication device.

11. The method of claim 10, further comprising translating the media to a form compatible with the first communication device based, at least in part, on the capabilities information.

12. A method, comprising:
identifying location information of a first and second media device using a communication technology;
exchanging communication information associated with the first and second media devices for establishing an Internet Protocol (IP) tunnel; and
providing media through the IP tunnel between the first and second media devices independent of the communication technology.

13. The method of claim 12, further comprising exchanging security parameters for securing the IP tunnel between the first and second media devices.

14. A method, comprising:
exchanging location information and communication information using out-of-band signaling; and
providing peer-to-peer multimedia using the location information and the communication between media devices.

15. The method of claim 14, the communication information comprising information regarding sessions supported by the media devices and characteristics of the media devices.

16. A method, comprising:
identifying a first media device using a communication technology associated with a communication device;
receiving media from the identified media device independent of the communication technology; and
translating the media to a format compatible with a media device.

17. The method of claim 16, further comprising exchanging information with a network element directly coupled to the first media device for establishing an IP tunnel between the first and the second media device.

18. A method, comprising:
receiving a request to establish a call with a communication device using a communication technology;
identifying location information associated with the communication device based, at least in part, on the communication technology;
receiving a request to transmit media to a media device associated with the communication device; and
transmitting the requested media to the media device using the location information and independent of the communication technology.

19. The method of claim 18, the media device comprising a first media device, the method further comprising:
receiving a response to the call request from a second communication device; and
transmitting to a second media device a request for the media.

20. The method of claim 18, further comprising translating the media to a form compatible with the first communication device based, at least in part, on the capabilities information.
